(19) United States
(12) Patent Application Publication
(10) Pub. No.: US 2003/0060897 A1
(43) Pub. Date: Mar. 27, 2003

(54) Commercial effect measuring system, commercial system, and appealing power sensor

(76) Inventors: Keisuke Matsuyama, Machida-shi Tokyo (JP); Norio Watanabe, Tokorozawa-shi Saitama (JP)

Correspondence Address: WENDEROTH, LIND & PONACK, L.L.P., 2033 K STREET N. W., SUITE 800, WASHINGTON, DC, 20006-1021, US

(21) Appl. No.: 10/239,472

(22) PCT Filed: Mar. 26, 2001
(86) PCT No.: PCT/JP01/02379

(30) Foreign Application Priority Data
Mar. 24, 2000 (JP) 2000-84029
Apr. 14, 2000 (JP) 2000-113322
Aug. 25, 2000 (JP) 2000-254807

(51) Int. Cl. G05B 15/00

(52) U.S. Cl. 700/1

(57) ABSTRACT

Commercials of high appealing power are released by making use of an automatic vending machine. A commercial selling device 10 has a display unit attached to the automatic vending machine 12 and adapted to release a commercial image with sound read out from a recorded medium 15A, which is regularly or irregularly rewritten by a commercial supply server 18 through the Internet 17. The product of the appealing power of the release commercial by the releasing time is measured by a commercial accounting server 24 so as to charge an advertisement rate of the commercial released to a commercial sponsor.

### TECHNICAL FIELD

This invention relates to a system for measuring the effect of a commercial on a television or the like, an appealing power sensor for use in the system, and a commercial system.

### BACKGROUND ART

A variety of commercials have been put on television and in newspapers or the like for advertising products or services.

The so-called mass media for these commercials are intended for numbers of people such as television audiences or newspaper readers, thus to proportionally run up advertisement rates to be borne by a commercial advertiser.

In the meantime, a commercial message has no effect merely when being televised or run in the newspaper, but the issue could be an appealing rate at or an actual appealing efficiency with which the television audiences or newspaper readers pay attention to the commercial message televised or appearing in the newspapers.

In case of the television commercial for example, the appealing power (advertising effect), which should affect its advertisement rate, is established according to anticipated audience ratings, taking no notice of the actual number of television audiences. Likewise, in the newspaper advertisement, the advertisement rates are charged depending only on the variety such as national newspaper, local newspaper, weekend edition, and weekday edition, taking no notice of the number of newspaper readers who actually read the newspaper.

Hence, the commercial sponsors have felt the establishment of the advertisement rate to be indefinite.

### DISCLOSURE OF THE INVENTION

This invention was made in the light of the problems raised by the conventional system noted above and seeks to provide a system for measuring actual commercial effect and a commercial system having high commercial appealing efficiency, which is capable of increasing the chances of permitting television audiences to actually view the commercial broadcasted.

This invention further seeks to provide a commercial system capable of establishing an advertisement rate according to the appealing power for commercial viewers who actually view the commercial broadcasted.

In order to accomplish the aims described above according to this invention, there is provided a commercial effect measuring system comprising an appealing power sensor disposed near a display unit for showing a commercial image with sound to measure the appealing power by detecting the number of viewers' faces looking toward the display unit and measure viewing time by the detecting cycle time and an arithmetic unit for calculating an advertising effect on the basis of a detection signal issued from the appealing power sensor and the time of releasing the commercial image and sound during the course of outputting the detection signal from the appealing power sensor.

The aforementioned appealing power sensor may include an infrared sensor for detecting infrared rays radiated from the faces of the viewers.

The system of the invention may further comprise a commercial effect integrating server connected to multiple arithmetic units mentioned above through wired or wireless lines to integrate calculated values delivered from the arithmetic units with respect to each commercial image and sound.

The aforementioned commercial effect integrating server may be designed to output a stop signal for halting releasing of the commercial image and sound when an integrated value reaches a budgetary value predetermined for each of the corresponding commercial images and sounds.

The aforementioned display unit is a television. The aforementioned appealing power sensor may detect the face of the television viewer in a television watching pose.

The aforementioned display unit may be mounted on the front panel of an automatic vending machine or near the automatic vending machine in a state of being directed toward a user.

The aforementioned appealing power sensor may detect distinctively the faces of the viewers in multiple detection zones sectionalized in accordance with the distance from the aforementioned display unit.

To accomplish the aims described above according to this invention, there is further provided a commercial system comprising a display unit for showing a commercial image with sound, an appealing power sensor for measuring the appealing power by detecting the number of viewers' faces looking toward the display unit within a predetermined area from the display unit and measure viewing time by the detecting cycle time, means for calculating an advertising effect on the basis of a detection signal issued from the appealing power sensor and the time of releasing the commercial image and sound during the course of outputting the detection signal from the appealing power sensor with respect to each sort of the commercial images with sounds shown on the display unit, and means for integrating calculated value signals collected from the calculating means through wired or wireless lines with respect to each of the commercial images with sounds shown on the display units, wherein advertisement rates are charged to commercial sponsors in accordance with values integrated by the integrating means.

The aforementioned commercial effect integrating means may be designed to output a stop signal for halting releasing of the commercial image and sound when the integrated value reaches a predetermined advertisement rate.

The advertisement rate may be charged in accordance with the value integrated up to the expiration of releasing count prescribed previously with respect to each of the commercial images and sounds.

To accomplish the aims described above according to this invention, there is further provided a commercial system comprising a display unit capable of showing a commercial image with sound, which is mounted on at least one position of a position adjacent to an automatic vending machine and the front panel of the automatic vending machine, wherein the commercial image with sound, which is given from at least one of a commercial providing server serving as a commercial supplying source and a recording medium storing information of the commercial images with sound, is shown on the aforementioned display unit, and an appealing power sensor disposed near a display unit for showing a commercial image with sound to measure the appealing power by detecting the number of viewers' faces looking toward the display unit and measure viewing time by the detecting cycle time, whereby an advertisement rate is charged to an commercial sponsor in accordance with the aforementioned releasing time and the aforementioned appealing power.

The aforementioned recording medium may be detachably attached to a writing/reading device, so that the image and sound data stored therein can be replaced regularly or irregularly with new information data of commercial images and sounds to be displayed from the commercial providing server.

Alternatively, the aforementioned recording medium may be attached to the writing/reading device, so that the image and sound data stored therein can be rewrote regularly or irregularly with new information data of commercial images and sounds, which are sent from the commercial providing server directly or through the writing/reading device.

Further, releasing of the commercial image with sound to be shown on the display unit may be controlled by the commercial controlling server connected to the aforementioned display unit through a wired or wireless line in order to charging the commercial sponsor with the advertisement rate in accordance with the time of releasing the commercial image with sound.

The aforementioned advertisement rate may be determined in accordance with the releasing time of the aforementioned commercial image with sound, the appealing power indicating the degree at which the displayed commercial image with sound appeals to viewers being around the automatic vending machine and a watching record determined from a product of at least the aforementioned releasing time and the appealing power with respect to the viewers being around the automatic vending machine, who are deemed to watch the relevant commercial image with sound.

The appealing power of the aforementioned commercial image with sound may increase as a user or purchaser comes to the automatic vending machine.

Further, it may be designed to maximize the appealing power of the aforementioned commercial image with sound in the time of 5 seconds to 30 seconds just after a purchaser has picked out an article of merchandise from the aforementioned automatic vending machine when buying.

Moreover, one measuring factor of the appealing power and the number of purchasers or users, preferably the appealing power, may be measured by the appealing power sensor disposed near the aforementioned display unit, so that the advertisement rate can be determined on the basis of the watching record, which is represented by a product of the measured value of the aforementioned appealing power sensor and the time of releasing the commercial image with sound, while displaying at least one sort of commercial images with sounds on the aforementioned display unit. The commercial images and sounds may be switched one another in accordance with the measured value obtained by measuring the appealing power with the appealing power sensor disposed near the aforementioned automatic vending machine. The aforementioned appealing power sensor may include an infrared sensor for detecting infrared rays radiated from the faces of the users.

Furthermore, the aforementioned appealing power sensor may include an infrared line sensor capable of measuring the positions and number of the users by detecting infrared rays radiated from the faces of the users.

The aforementioned infrared line sensor may have a plurality of infrared detecting elements arranged in a matrix form in each of detecting segments corresponding to concentric arc-zonate areas around the automatic vending machine.

The aforementioned appealing power sensor may operate at intervals of 0.1 to 10 seconds to detect the uses therearound at 50 μsec. to 200 μsec.

The advertisement rate to be charged to the commercial sponsor may be determined for each sort of the commercial images and sounds in accordance with the integrated value of at least the releasing time and the appealing power selected from measuring factors including the time of releasing the commercial image with sound from the aforementioned display unit, the appealing power and the number of users and stored in the memory device of the display unit, while reading out the measuring factors from the memory device.

Alternatively, the advertisement rate to be charged to the commercial sponsor may be determined for each sort of the commercial images and sounds in accordance with the integrated value of at least the releasing time and the appealing power selected from the measuring factors including the time of releasing the commercial image with sound from the aforementioned display unit, the appealing power and the number of users and stored in the aforementioned recording medium of the display unit, while reading out the measuring factors from the recording medium.

As an alternative, the advertisement rate to be charged to the commercial sponsor may be determined for each sort of the commercial images and sounds in accordance with the integrated value of at least the releasing time and the appealing power selected from measuring factors including the time of releasing the commercial image with sound from the aforementioned display unit, the appealing power and the number of users and stored in the aforementioned recording medium of the display unit, while reading out the measuring factors from the recording medium through a wired or wireless line by using a commercial accounting server.

Further, the commercial image with sound may be continuously released from the aforementioned display unit in the middle of selling commodities by the automatic vending machine at a reduced price or at no charge.

A part of advertisement rate collected from the commercial sponsor may compensate for the price of the commodity to be sold by the automatic vending machine at a reduced price or at no charge in the manner mentioned above.

Further, the appealing power of the commercial image with sound, which is continuously released from the aforementioned display unit in the middle of selling commodities by the automatic vending machine at a reduced price or at no charge, may be determined at the same level as that in the time of 5 seconds to 30 seconds just after the user has picked out an article from the aforementioned automatic vending machine when buying.

The commodities to be sold at a reduced price or at no charge by the automatic vending machine may be digital recording media containing at least one of sound and image.

The sale of commodities in the aforementioned automatic vending machine may be allowed by confirming credit worthiness of the user or purchaser with the use of a personal identification means such as an IC card, personal identification number and credit card. When identifying the user using the automatic vending machine, a commercial image with and sound congenial to the user may be released from the aforementioned display unit upon recognizing the personality of the user.

When using the aforementioned automatic vending machine, samples of commercial images by type of commercials are displayed on the aforementioned display unit, so that the user may select the commercial image of user's own choice from the samples of commercial images by operating a commercial selection means disposed on the aforementioned automatic vending machine so as to release the selected commercial image for a given length of time.

The automatic vending machines may be categorized to groups according to characteristics peculiar to their installation locations and supplied with commercial images and sounds tailored to the uses' preferences according to the selected groups.

Some of automatic vending machines may be selected according to the reservation of a client, so that an commercial image with sound ordered by the client is supplied to the selected automatic vending machine to show the ordered commercial image with sound on the display unit of the selected automatic vending machine.

One of the aforementioned commercial providing server and a commercial reception server for inputting the commercial image and sound to the commercial providing server may be connected to the system of the registered client through a line network capable of transmitting data of images and sounds, so as to comply with the client's order for at least one of releasing time and period, estimated cost, service area in addition to the ordered commercial image and sound.

The aforementioned commercial supplying source may be a cable television provider, satellite broadcasting station, or ground-based broadcasting station.

As an alternative, the aforementioned commercial supplying source may be one of a public institution such as police office, fire station, emergency station, state organization, and local governmental units, so as to broadcast a public service announcement with the aforementioned display unit via the Internet or through the other medium. Further, to accomplish the aims described above according to this invention, there is provided an appealing power sensor for detecting a commercial effect, comprising an infrared line sensor capable of measuring the positions and number of the users by detecting infrared rays radiated from the faces of the users, which infrared line sensor includes infrared detecting elements arranged in a matrix form in each of detecting segments corresponding to concentric arc-zonate areas disposed around the automatic vending machine.

The aforementioned appealing power sensor may be operated at intervals of 0.1 to 10 seconds to detect the users therearound at 50 μsec. to 200 μsec.

According to the present invention, since the commercial image with sound is released toward a purchaser who actually buys commercial goods from the automatic vending machine, persons around the vending machine, or persons facing to the vending machine, the appealing effect brought about by the commercial system of the invention can be heightened.

### BRIEF DESCRIPTION OF THE DRAWINGS

FIG. 1 is a block diagram showing one embodiment of a commercial system according to the present invention.

FIG. 2 is a plan view schematically showing a detection zone of an appealing power sensor in the commercial system of the invention.

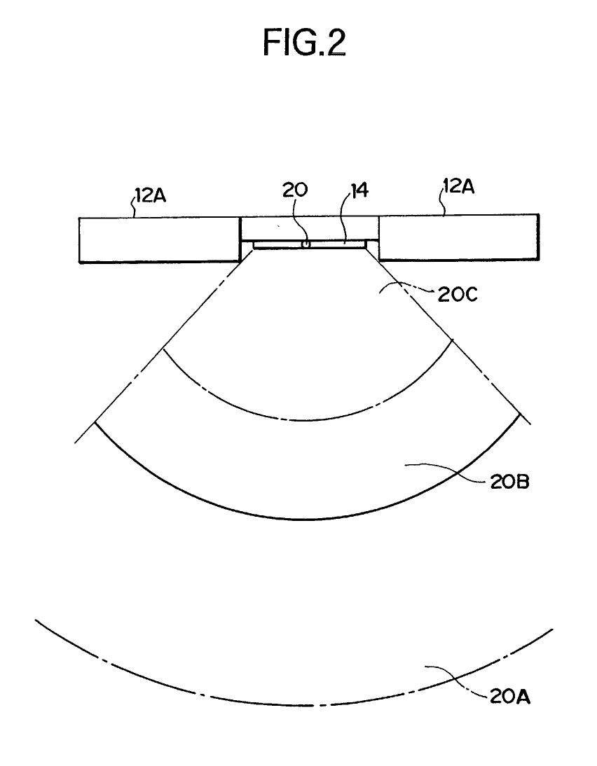

FIG. 3 is a plan view showing in detail an infrared line sensor in the appealing power sensor of the invention.

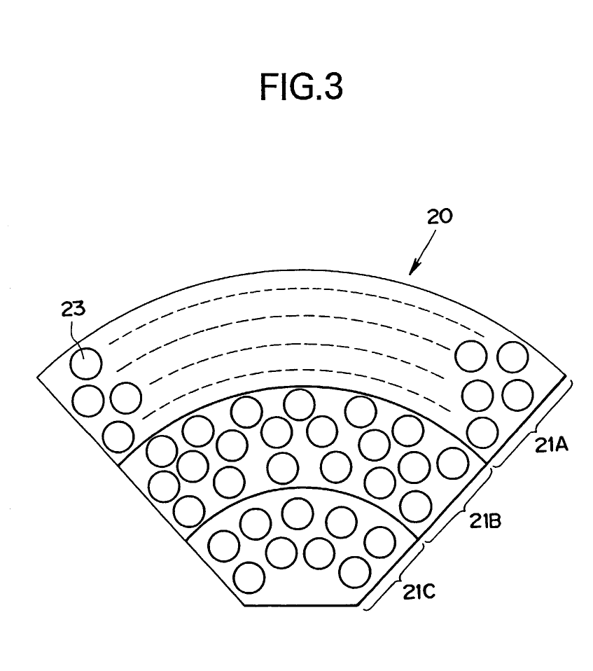

FIG. 4 is a front view showing a display unit in a commercial selection mode in the system of the invention.

FIG. 5 is a block diagram showing the state of providing commercial contents to a plurality of automatic vending machines categorized in the system of the invention.

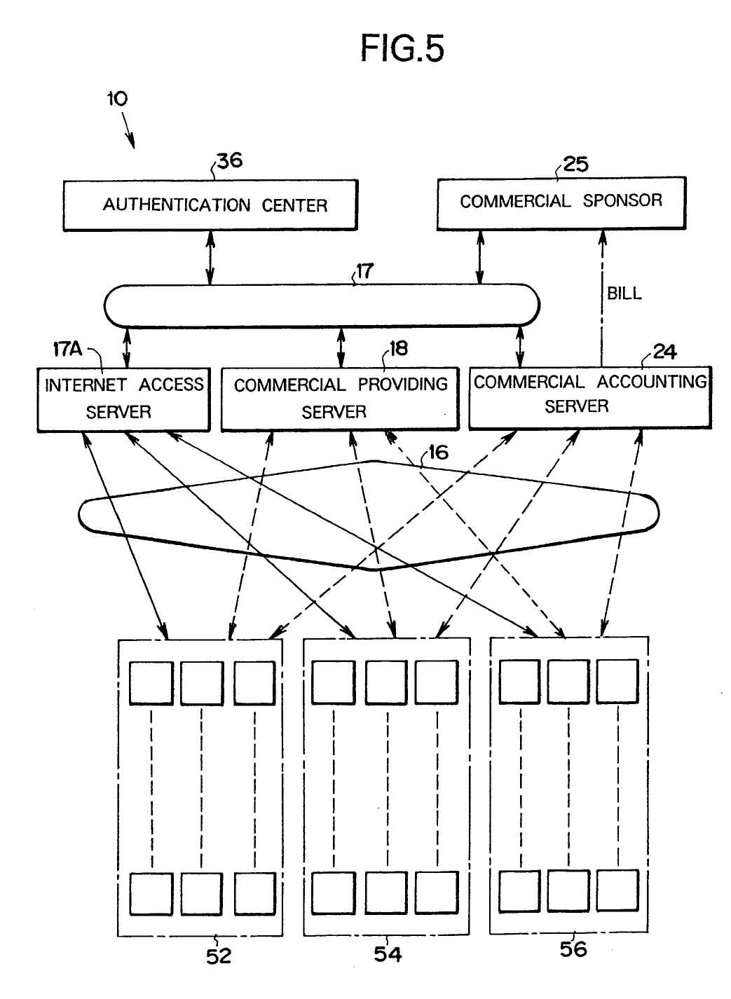

FIG. 6 is a block diagram showing a third embodiment of the commercial system according to the invention.

FIG. 7 is a block diagram showing another embodiment of the commercial system according to the invention.

### BEST MODE FOR CARRYING OUT THE INVENTION

Various embodiments of the present invention will be described hereinafter with reference to the accompanying drawings.

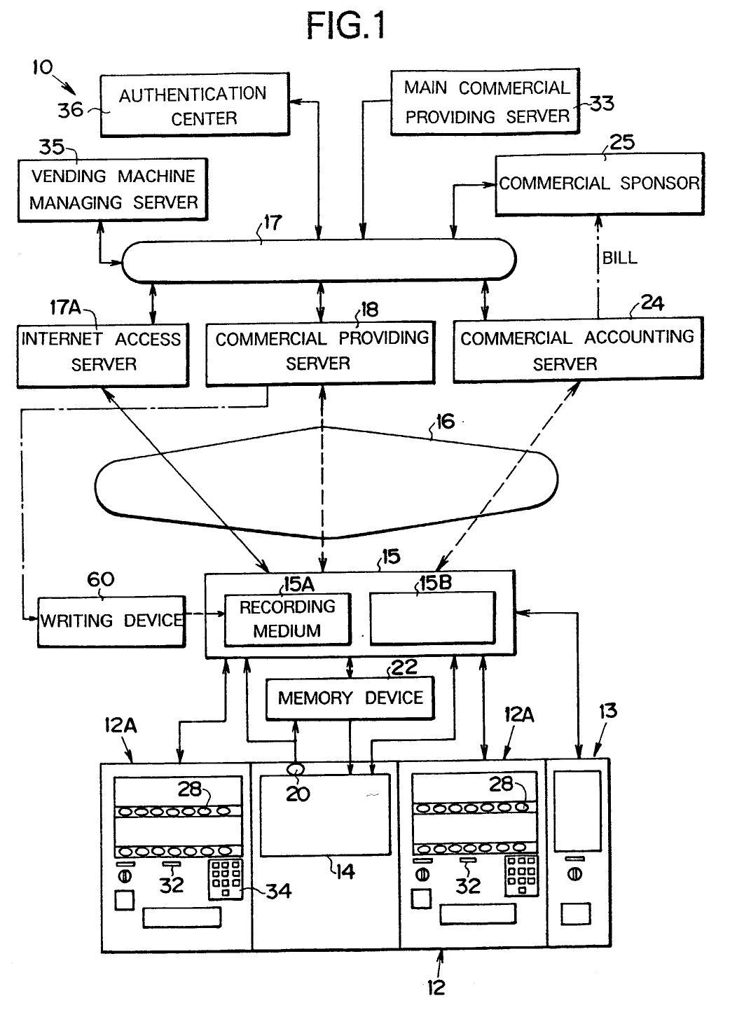

FIG. 1 is a block diagram showing in detail the configuration of the commercial system according to the present invention. A commercial vending device 10 is disposed adjacent to an automatic vending machine 12, and comprises a display unit 14 such as a plasma display for releasing commercial images and sounds, a recording medium 15A for storing the commercial images and sounds to be released from the display unit 14, a writing/reading device 15B for reading out the commercial images and sounds to be displayed on the aforementioned display unit 14, a set-top box 15 having an Internet-connection function, a public telephone line 16, the Internet 17, an Internet access server 17A, a commercial providing server 18 serving as a commercial supplying source for supplying the commercial image and sound information to the aforementioned recording medium 15A, an appealing power sensor 20 disposed near the aforementioned display unit 14 to measure appealing power affecting the persons near the automatic vending machine 12 and the number of persons having faces looking toward the display unit 14, a memory device 22 for recording the sort and releasing time of the commercial images and sounds released from the display unit 14 and the values measured by the appealing power sensor 20, and commercial accounting server 24 for finding the product (watching record) of the releasing time, appealing power and the number of persons with respect to the types of the commercial images and sounds upon reading out information stored in the aforementioned memory device 22 through the public telephone line 16, Internet 17, Internet access server 17A and set-top box 15, and calculating the advertisement rate to be charged to a commercial sponsor 25 in accordance with the watching record.

The recording medium 15A attached to the aforementioned set-top box 15 is formed of a hard disk, memory card, DVD (e.g. DVD-R, DVD-RW, and DVD-RAM), or CD (e.g. CD-R, and CD-RW) for storing multiple sorts of commercial images and sounds, so that for example, one commercial image with sound can be repeatedly released in sequence for 15 to 30 seconds.

This recording medium 15A is updated at regular or odd intervals by using the Internet 17 or manually to rewrite the commercial images and sounds to be released from the display unit 14. At the time of manually updating the contents in the recording medium, it is desirable to carry on replenishing of commodities, collecting of sale proceeds, and maintenance of the automatic vending machine.

Incidentally, there is shown only one commercial providing server 18 in FIG. 1. However, in a case of providing the commercial image with sound to a great number, e.g. one million, of automatic vending machines, a plurality of commercial providing servers 18 may be spread across numerous locations so as to permit the commercial images and sounds to be provided to or rewrote in the memory media 15A of the respective automatic vending machines in a short period of time. In this case, it is desirable to provide the commercial image and sound information from a main commercial providing server 33 to a plurality of commercial providing servers 18 through the aforementioned public telephone line 16 and Internet 17, as shown in FIG. 1. The commercial accounting server 24 is connected to many automatic vending machines 12.

The aforementioned automatic vending machine 12 has a plurality of automatic vending machine bodies 12A arranged abreast and the display units 14 of large size such as plasma displays each placed between the respective automatic vending machine bodies, as shown in FIG. 1.

Reference numeral 30 in FIG. 1 denotes a control device for controlling the automatic vending machines 12 so as to transmit information on inventory management, sales information, maintenance information and the like to a vending machine managing server 35 through the set-top box 15 and Internet 17.

The commercial image with sound read out from the recording medium 15A through the writing/reading device 15B is continuously released from the display unit 14 in service. In this case, a silent commercial image may be displayed for prevention of noise in the middle of the night.

The commercial image with sound may be released from the display unit 14 without being stored in the recording medium 15A. In this case, it is desirable to connect the commercial providing server 18 and the display unit 14 to each other through a private line. The release of commercial may be performed by using one cablecast channel of a cable television broadcast station offering continuous connection broadcasting service.

In the case of releasing the commercial without using the recording medium 15A, the commercial providing server 18 serves as a commercial controlling server for permitting the same commercial image to be displayed on all the display units 14 of the automatic vending machines connected thereto.

The aforementioned appealing power sensor 20 may include an infrared line sensor for detecting infrared rays radiated from the faces of the persons therearound. In a case of using a display having a 50-inch screen as the display unit 14, it may be so designed that a person staying in a first area 20A defined within a visible area of 5 to 10 meters around the display unit 14 is detected as a first level, and a person staying in a second area 20B within an area of 5 to 3 meters or a third area 20C within an area of 3 meters or less is detected as a second level or a third level, respectively. Also, a situation that a person comes near the automatic vending machine 12, inserts money into the automatic vending machine, and staying there for 5 seconds to 30 seconds after pressing one or more commodity selection buttons 28 may be defined as a fourth level. The value detected as the fourth level is outputted to the memory device 22. The fourth level is detected with an ON signal issued by operating the commodity selection buttons 28.

The aforementioned first to third areas 20A-20C assume belt-like concentrically arcuate forms centering on the display unit 14.

The infrared line sensor of the aforementioned appealing power sensor 20 comprises a number of infrared detecting elements 23 arranged in arcuate rows in each of concentric arc-zonate segments 21A-21C corresponding to the first to third areas 20A-20C so as to detect the persons who present in the respective first to third areas 20A-20C as noted above. Thus, the number of persons having faces looking toward the display unit 14 in each of the first to third areas 20A-20C can be calculated by detecting the outputs from the infrared detecting elements 23 which detect the infrared radiation in the respective segments 21A-21C.

To be more specific, the aforementioned appealing power sensor 20 has the infrared detecting elements 23 configured to detect the infrared radiation from a human face, so as to detect only the persons with faces looking toward the display unit 14, but not detect the persons looking aside even when existing in the aforesaid first, second and third areas 20A, 20B and 20C. That is, the persons who do not look at the commercial image shown on the display unit 14 are not detected. Incidentally, the temperature of a human face is almost fixed in general irrespective of change in environmental temperature.

In concrete terms, the infrared line sensor has a structure in which an infrared image generated in the aforementioned first to third areas 20A-20C is focused onto the tip end of the infrared detecting elements 23 in the aforementioned segments 21A-21C with a lens.

On the assumption that the sensor detects a person watching a commercial image for 0.5 seconds in one detecting operation of the aforementioned appealing power sensor 20, which is performed at short time intervals of 0.5 seconds for instance, the person is deemed as a commercial viewer even if the person moves in the aforementioned first to third areas 20A to 20C. Hence, the appealing power and the number of the commercial viewers can be calculated independently of whether the person counted is the same one or a different person newly entering therein.

The speed of response of the aforementioned infrared detecting element 23 may be set to about 70 μsec. so as to thoroughly detect even a person moving at a slow pace.

The aforementioned memory device 22 has a function of storing the type and releasing time of the released commercial and the number of the commercial viewers on each of the aforementioned first, second, third and fourth levels and a state in which the person is not within the areas of 10 m from the display unit 14.

The aforementioned commercial accounting server 24 is provided for reading out the data stored in the memory device 22 through the public telephone line 16, Internet 17 and/or set-top box 15 at regular time intervals, e.g. on a daily, weekly or monthly basis.

This commercial accounting server 24 calculates an advertisement rate with respect to each commercial sponsor on the basis of the releasing times of the commercial images and sounds released in the state in which commercial viewers are near the automatic vending machine, the number of the commercial viewers, the product of the appealing power also serves as a commercial providing server capable of controlling the aforementioned writing/reading device 15B, so that when the advertisement rate calculated sequentially for every commercial sponsor reaches, for example, the budgetary value (specific sum) predetermined by the commercial contract with the commercial sponsor, the writing/reading device 15B is controlled to stop reading of the aforesaid commercial, consequently to suspend releasing of the commercial from the display unit 14. Alternatively, the commercial may be released for a fixed period of time, subject to a predetermined commercial rate irrespective of the appealing power, without use of the aforementioned appealing power sensor 20.

The commercial appealing effect brought about by the aforementioned commercial vending device 10 will be weighed here against those of television commercial messages released in the customary way

It has been supposed that there are 2,500,000 or more automatic vending machines for dispensing soft drinks in all parts of Japan now. Assuming that the quantity of the annual total sales of canned soft drinks and bottled soft drinks sold by the automatic vending machine is divided by 2,500,000 units of automatic vending machines, it is perceived that 20 soft drinks have been sold a day with one automatic vending machine on the national average.

The unit sales of 20 soft drinks a day is mere the average per automatic vending machine, but the maximum unit sales of soft drinks with one automatic vending machine is considered to be 200 soft drinks a day in the light of the annual average thereof.

Supposing that 100 soft drinks are sold a day with an automatic vending machine set at a location enjoying a good sale, two automatic vending machine might well sell 200 soft drinks a day Therefore, when two of the aforementioned automatic vending machines 12 are installed there in pairs and provided with one display unit 14, it is conceivable that at least 200 persons will approach the display unit 14 to watch the commercial image with sound released from the display unit.

Since the user of the automatic vending machine will stand near the display unit for at least 30 seconds whenever the user effects a purchase of the soft drink from the vending machine, the commercial appealing effect at that time is regarded as being nearly equal to that obtained in eagerly watching a television commercial.

In the case of the television commercial, the audience appreciation rating of a television program generally becomes an issue. In a case where broadcasts including twenty of 15-second commercials per hour go on the air for 20 hours a day in a television station and are viewed for 5 hours a day at a viewing rating of 10% on average, the effective commercial time a day on one television set will become 37.5 seconds when an audience rating of commercial viewers among those who are watching the television programs is 30%.

In this relation, one display unit mounted on one set of two automatic vending machines each used by 100 users will be watched by 200 users for about 30 seconds while spitting out an article for sale. On the assumption that 200 passers-by who pass by the display unit a day come to a stand to view the commercial shown on the display unit for about 15 seconds, the effective commercial time will turn out about 9,000 seconds a day per one set of automatic vending machine.

Consequently, the set of automatic vending machines might well have a commercial appealing effect brought about by 240 units of television sets. If 10,000 sets of the automatic vending machines are installed by way of example, they come to the same thing as two and a half million units of television sets.

For instance, the aforementioned appealing power sensor 20 with the aforementioned infrared line sensor detects a person who enters in the area of 10 meters to 5 meters or 5 meters to 3 meters from the display unit 14 or within 3 meter of the display unit 14 and turns his face toward the display unit 14, and records the person one by one onto the memory device 22 to accumulate the number of persons viewing the commercial shown on the display unit. Also, the appealing power sensor 20 detects a user who presses one or more commodity selection buttons 28 on the automatic vending machine 12 in buying a desired article and outputs to the memory device 22 a signal as the highest appealing power which is obtained in a stated length of time, e.g. 30 seconds, after selecting the desired article.

This is because the user of the automatic vending machine usually stays near the automatic vending machine 12 for a specific time after pressing at least one of the commodity selection buttons 28. Specifically, when the user drinks a canned soft drink bought there, the user will stay there for a while, consequently to increase the probability of viewing the commercial image with sound shown on the display unit 14.

Furthermore, when some users stand in line in front of the automatic vending machine 12, the probability of allowing the users to view the commercial displayed on the display unit in the waiting time for buying soft drinks can be increased.

The items to be detected by the aforementioned appealing power sensor 20 may include various factors other than the situations on whether a person stays within the specific area in front of the display unit 14 and whether a user presses at least one of the commodity selection buttons 28 as mentioned above in order to increase degree of certainty of the appealing power.

Even a person existing or passing outside 10 meter from the display unit 14 may be accounted to be record on the memory device 22 when a large-sized display over 70 inches is used as the display unit 14, because an image displayed on the large-sized display is sufficiently viewable even from far away.

According to this manner, even when a mere passer-by directs his attention to the commercial image displayed on the display unit 14, this fact may be reflected on the appealing power of the commercial.

In such a case, the detection level of the aforementioned appealing power sensor 20 may be subdivided, so that a passer-by in the area of 10 to 15 meters from the display unit 14 can be detected.

In the case noted above, the appealing power sensor 20 may perform the detection function every 0.5 seconds, so that one who passes by in front of the display unit is detected as a viewer of the commercial image with sound on the display unit on the supposition that the passer-by who comes to a stand or turns his face toward the display unit while walking views the commercial image on the display unit.

The detection cycle and response time of the appealing power sensor 20 may be determined to 0.1 to 10 seconds and 50 μsec. to 200 μsec. according to the installation conditions of the automatic vending machine 12.

In the aforementioned commercial system, one or more sorts of the commercial images and sounds are released from the display unit 14 in repeating fashion, and variety of commercial images and sounds may be switched to one another according to the value detected by the appealing power sensor 20.

The magnification and kind of the image to be displayed may vary according to the situation, e.g. the case where a person stands in close to the display unit 12 and the case where a person is 5-10 meters away from the display unit.

For instance, the appealing power when the person is relatively apart from the display unit 14 is increased as the magnification of the image to be displayed is made large. Thus, when the person is in the distance from the display unit, the image to be displayed may be enlarged, and when the person come close to the display unit, the image may be displayed in distant view.

Further, the aforementioned automatic vending machine may be provided with a reader/writer as an element 32 shown in FIG. 1 by way of example, so as to allow an user to buy an article by inserting an IC card or credit card for verifying identity into the reader/writer 32 or keying the personal identification password of the user into the automatic vending machine. In this case, the personal identifying information of the user thus inputted to the automatic vending machine is transferred to an authentication center 36 through the set-top box 15, public telephone line 16 and Internet 17, so as to enable the commodity selection buttons 28 when authenticating the user identification. When enabling the commodity selection buttons, a commercial image with sound, which is deemed holding attraction for the user, may be displayed on the display unit by means of the commercial accounting server 24 serving as the aforementioned commercial controlling server on the basis of the record of articles purchased by the user in past.

Thus, this commercial system can preclude vain commercial images and sounds from being released, consequently to increase the appealing power of the commercial.

In either of the embodiments described above, the commercial images and sounds stored in the memory device are released independently of the user's will. By letting the user select the user's own favorite image and sound, it becomes possible to more increase the appealing power and comprehend the user's preference.

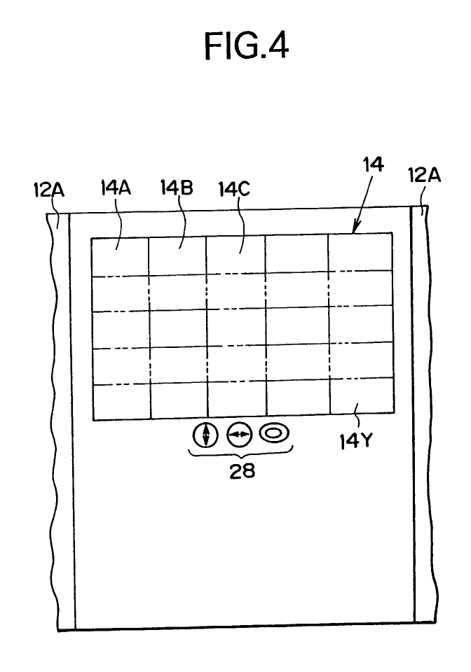

In concrete terms, just after the user selects a specific article by operating the commodity selection buttons 28 as shown in FIG. 4, the display unit 14 is put in a commercial selection mode in which all the commercial images stored in the memory device are instantiated in multiple sections 14A, 14B . . . 14Y into which the screen of the display unit 14 is divided for purposes of illustration, so that the user can select his own favorite image from the images instantiated on the display unit by operating commodity selection buttons 28A, a touch-sensitive panel or the commodity selection buttons 28, to display the selected image on the display unit. The appealing power of the commercial thus selected and released is considerably large.

The commercial system in each of the foregoing embodiments according to the invention essentially serves to release the commercial images and sounds with large appealing power, making use of opportunities for the user to buy soft drinks or the like from the automatic vending machine 12, but should not be limited to such functions. Specifically, the commercial system of the invention may have the ability to pull in more users or purchasers to increase the appealing power of the commercial.

By way of example, the automatic vending machine 12 may be united with a CD vending machine to distribute free or sell music CDs at deep discounts or specific commodities capable of attracting purchasers, consequently to have lots of purchasers queued for commodities. Then, the commercial image with sound is continuously displayed on the aforementioned display unit 14 for purchasers' queue, thus to achieve remarkably high appealing power of the commercial message released from the display unit.

In this case, it is desirable to continuously release the commercial images and sounds from the aforementioned display unit 14 in the state of determining the appealing power of the commercial to the high rate irrespective of the value detected by the appealing power sensor 20.

The appealing power obtained at that time may be looked as identical with that immediately after the purchaser purchases an article from the automatic vending machine 12, because many purchasers standing in queues view the commercial image with sound for a long time.

The advertising rates for the commercial images and sounds released, which are collected from the commercial sponsors, may be returned in part to the purchasers in the form of discount or free distribution.

In the foregoing embodiment, the single automatic vending machine is illustrated, but in fact, the commercial images and sounds are distributed from the commercial providing server 18 to a large number of automatic vending machines through the Internet 17 and/or by using the recording medium 15A

In such a case, it is desirable to install the automatic vending machines in categorized areas such as a business district 52, area around the station 54 and entertainment district 56 and distribute commercial images and sounds in different manners suitable for the respective areas or in a combination, so as to secure the maximum commercial appealing effect.

As an alternative, many automatic vending machines may be categorized on the basis of administrative districts, specific districts along railroad lines and youth populous districts in accordance with the variety of commercials.

Next, the manner of entering the commercial images and sounds into the aforementioned commercial providing server 18 or main commercial providing server 33 will be described with reference to FIG. 1.

In general, the commercial image and sound are produced by an advertisement agency at the request of the commercial sponsor 25 and then inputted to the commercial providing server 18 or main commercial providing server 33 through the medium of a video tape, recording disk or the like.

The commercial providing server 18 or main commercial providing server 33 serve to distribute the produced commercial image and sound to the recording medium 15A of the set-top box 15 through the Internet 17 or by using recording means, assigning the commercial releasing time to the designated automatic vending machine according to need. Alternatively, the commercial image and sound may be inputted from a client server (not shown) on the side of the commercial sponsor 25 registered in advance directly to the commercial providing server 18 or main commercial providing server 33.

The commercial sponsor 25 inputs the commercial image and sound already produced to the client server connected thereto. At that time, the commercial sponsor selects one of the categorized installation locations for the automatic vending machines in order for releasing the desired commercial image and sound. Simultaneously, the commercial releasing time may be determined.

In the illustrated embodiment, when the commercial sponsor 25 is a public institution such as police and fire service, emergency, or state institutions such as governmental organization and local governmental units, there can be released expeditiously various public service information such as earthquake prediction information, meteorological warning message, and information on a criminal from the automatic vending machines located at the relevant places.

Even when the commercial sponsor 25 is a private company or an individual, the desired commercial information can be inputted in the matter of minutes without making troublesome preparation therefor and released to the relevant places in the required time zone.

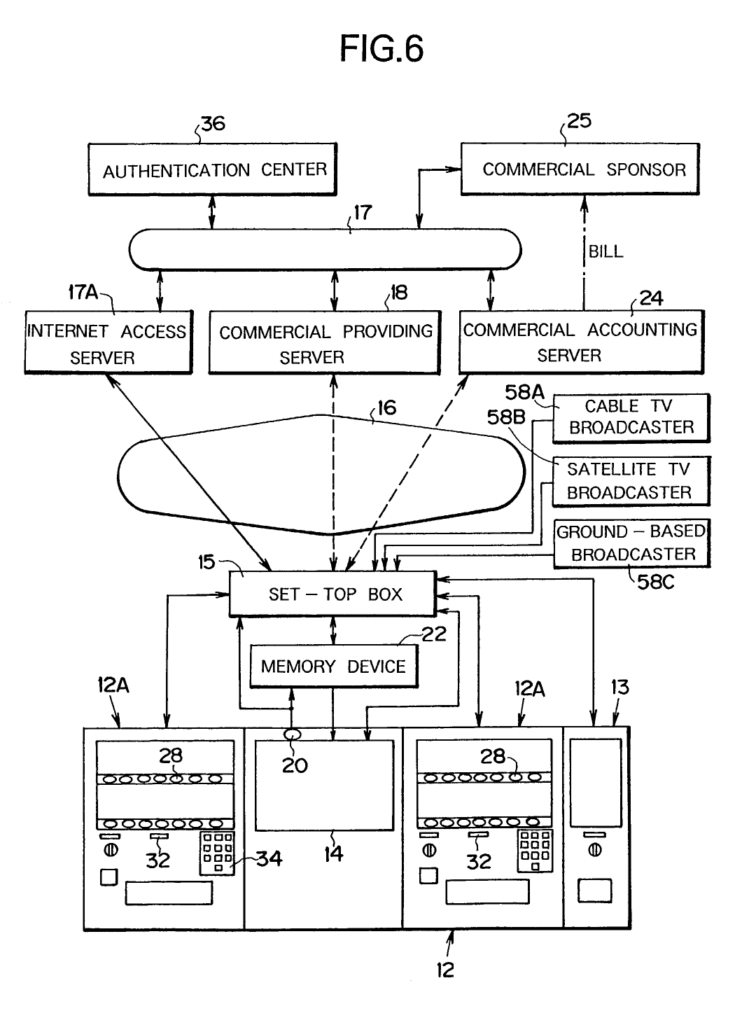

The commercial image with sound is released on the request of the specific commercial sponsor in the foregoing embodiments. The commercial image with sound may be transmitted to a set-top box 26 directly or through the Internet 17 in the form of television broadcasting signals in a cable television broadcaster 58A, satellite television broadcaster 58B and ground-based broadcaster 58C, which serve as the commercial supplying source, so as to be released from the display unit 14, as illustrated in FIG. 6.

In this case, live telecast of popular sports, broadcast of prominent news event or other suitable programs may be carried out when there is no necessity of displaying the commercial image on the display unit 14.

As an alternative, commercial images and sounds, which were downloaded previously from the broadcasts from the cable television broadcaster 58A or other sources, may be released.

Incidentally, the aforementioned recording medium 15A may be detachable from the aforementioned set-top box 15, so as to be exchangeable regularly or irregularly with another recording medium storing different commercial image and sound information supplied from the aforementioned commercial providing server 18. In this case, the commercial image and sound information written in the recording medium 15A attached to the aforementioned set-top box 15 may be rewritten with new commercial image and sound information regularly or irregularly, as illustrated in FIG. 1.

Further, the commercial providing server 18 may be made portable, so that it can be carried by the side of the automatic vending machine to write the commercial image and sound information stored in the recording medium 15Ain manual operation. When rewriting by using a writing device 60, new commercial image and sound information is previously inputted from the commercial providing server 18 to the writing device so as to be written in a recording medium 13 directly connected to the commercial providing server 18 nearby.

In the foregoing embodiments, the set-top box 15 is used for transmitting and receiving the commercial image and sound data relative to the commercial providing server 18 or other components and writing and reading the data, but should not be understood as being limitative. Instead, other connection servers or reading/writing devices may be used.

Also, the systems in the foregoing embodiments each employ the display unit 14 is mounted between the automatic vending machines 12A united in one unit. When the display unit 14 is formed of a low-profile display such as a plasma display, a storage unit for storing commodities to be dispensed by the automatic vending machines may be arranged behind the low-profile display. That is, the display unit 14 may be disposed in front of the united automatic vending machines.

The commercial systems in the foregoing embodiments are used for displaying the commercial image with sound on the display unit 14 disposed by the side of the automatic vending machine, but may be applied for measuring an advertising effect brought about by commercial messages telecasted by a television broadcasting service and collecting advertisement rates thereof.

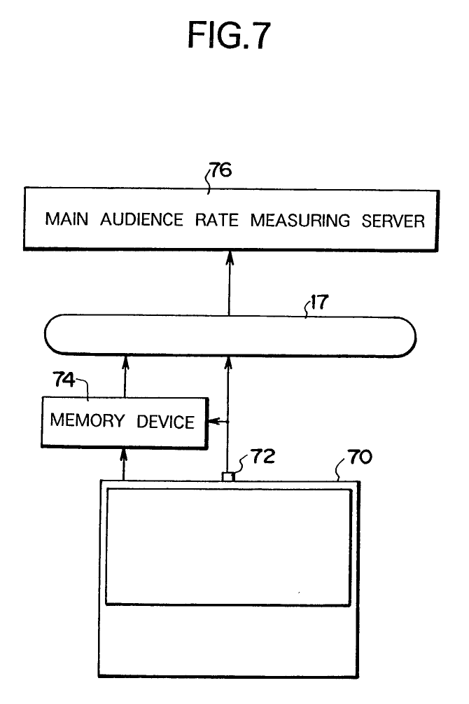

For instance, an appealing power sensor 70 may be attached to a television set 70 so as to detect the face of a viewer, as shown in FIG. 7. With this system, the actual number of viewers other than ones who watch a television program but do not see a commercial image with sound on the television screen of the television set can be measured. The situation in which no one watches television in its ON state is of course excluded from the measured appealing power.

An audience rate sensor 72 differs in function the appealing power sensor 20 and is so set as to detect the number of persons within a normal television viewable area.

The measured value obtained from the audience rate sensor 72 is recorded in a memory device 74 along with a television channel and time (or kind of commercial released), or transferred in real time to a main audience rate measuring server 76 through the Internet 17 without being recorded.

In the main audience rate measuring server 76, the values sent from all the audience rate sensors 72 are integrated to figure out the audience ratings for the respective commercials. In the accounting procedure in the commercial system of the invention, commercial fees are formulated previously so as to stop the release of the commercials when the integrated value reaches a prescribed budgetary value or collect the charges for the released commercials according to the integrated value from the pertinent commercial sponsor.

### INDUSTRIAL APPLICABILITY

The commercial system of the invention is applied for measuring a commercial effect on television broadcast. Moreover, the system serves to release commercial images and sounds for users of automatic vending machines with high appealing power.

1. A commercial effect measuring system comprising an appealing power sensor disposed near a display unit for showing a commercial image with sound to measure the appealing power by detecting the number of viewers' faces looking toward the display unit and measure viewing time by the detecting cycle time, and an arithmetic unit for calculating an advertising effect on the basis of a detection signal issued from said appealing power sensor and the time of releasing the commercial image and sound during the course of outputting the detection signal from said appealing power sensor.

2. The appealing power sensor set forth in claim 1, further comprising an infrared sensor for detecting infrared rays radiated from the faces of the viewers.

3. The appealing power sensor set forth in claim 1 or claim 2, further comprising a commercial effect integrating server connected to said arithmetic units through wired or wireless lines to integrate calculated values delivered from said arithmetic units with respect to each commercial image and sound.

4. The appealing power sensor set forth in claim 3, wherein said commercial effect integrating server is designed to output a stop signal for halting releasing of the commercial image and sound when the integrated value reaches a budgetary value predetermined for each of the corresponding commercial images and sounds.

5. The appealing power sensor set forth in any of claim 1 to claim 4, wherein said display unit is a television, and said appealing power sensor detects the face of the television viewer in a television watching pose.

6. The appealing power sensor set forth in any of claim 1 to claim 4, wherein said display unit is mounted on the front panel of an automatic vending machine or near the automatic vending machine in a state of being directed toward a user.

7. The appealing power sensor set forth in claim 6, wherein said appealing power sensor detects distinctively the faces of the users in multiple detection zones sectionalized in accordance with the distance from said display unit.

8. A commercial system comprising a display unit for showing a commercial image with sound, an appealing power sensor for measuring the appealing power by detecting the number of viewers' faces looking toward the display unit within a predetermined area from the display unit and measure viewing time by the detecting cycle time, means for calculating an advertising effect on the basis of a detection signal issued from said appealing power sensor and the time of releasing the commercial image and sound during the course of outputting the detection signal from said appealing power sensor with respect to each sort of the commercial images with sounds shown on said display unit, and means for integrating calculated value signals collected from said calculating means through wired or wireless lines with respect to each of the commercial images with sounds shown on said display units, wherein advertisement rates are charged to commercial sponsors in accordance with values integrated by said integrating means.

9. The commercial system set forth in claim 8, wherein said commercial effect integrating means is designed to output a stop signal for halting releasing of the commercial image and sound when the integrated value reaches a predetermined advertisement rate.

10. The commercial system set forth in claim 8, wherein said advertisement rate is charged in accordance with the value integrated up to the expiration of releasing count prescribed previously with respect to each of the commercial images and sounds.

11. A commercial system comprising a display unit for showing a commercial image with sound, said display unit being mounted on at least one position of a position adjacent to an automatic vending machine and the front panel of said automatic vending machine, said the commercial image with sound being given from at least one of a commercial providing server serving as a commercial supplying source and a recording medium storing information of the commercial images with sound and shown on said display unit, and an appealing power sensor disposed near a display unit for showing a commercial image with sound to measure the appealing power by detecting the number of viewers' faces looking toward the display unit and measure viewing time by the detecting cycle time, whereby an advertisement rate is charged to an commercial sponsor in accordance with the aforementioned releasing time and the aforementioned appealing power.

12. The commercial system set forth in claim 11, wherein said recording medium is detachably attached to a writing/reading device to regularly or irregularly replace the image and sound data stored therein with new information data of commercial images and sounds to be displayed from the commercial providing server.

13. The commercial system set forth in claim 11, wherein said recording medium is attached to a writing/reading device to regularly or irregularly rewrite the image and sound data stored therein with new information data of commercial images and sounds sent from said commercial providing server directly or through said writing/reading device.

14. The commercial system set forth in any of claim 11 to claim 13, wherein releasing of the commercial image with sound to be shown on said display unit is controlled by said commercial controlling server connected to said display unit through a wired or wireless line in order to charging a commercial sponsor with the advertisement rate in accordance with the time of releasing the commercial image with sound.

15. The commercial system set forth in any of claim 11 to claim 13, wherein said advertisement rate is determined in accordance with the releasing time of said commercial image with sound, said appealing power indicating the degree at which the displayed commercial image with sound appeals to viewers being around the automatic vending machine and a watching record determined from a product of at least said releasing time and said appealing power with respect to the viewers being around said automatic vending machine, who are deemed to watch the relevant commercial image with sound.

16. The commercial system set forth in claim 15, wherein said appealing power of the commercial image with sound increases as a user comes to said automatic vending machine.

17. The commercial system set forth in claim 15 or claim 16, wherein the appealing power of the commercial image with sound is determined to be made maximum in the time of 5 seconds to 30 seconds just after a user has picked out an article of merchandise from said automatic vending machine when buying.

18. The commercial system set forth in claim 15, claim 16 or claim 17, wherein at least the appealing power selected from one measuring factor of the appealing power and the number of users is measured by said appealing power sensor disposed near said display unit so as to determine the advertisement rate on the basis of the watching record, said advertisement rate being represented by a product of the measured value of said appealing power sensor and the time of releasing the commercial image with sound, while displaying at least one sort of commercial images with sounds on said display unit.

19. The commercial system set forth in claim 15, claim 16 or claim 17, wherein said commercial images and sounds are switched one another in accordance with the measured value obtained by measuring the appealing power with said appealing power sensor disposed near said automatic vending machine.

20. The commercial system set forth in claim 18 or claim 19, wherein said appealing power sensor includes an infrared sensor for detecting infrared rays radiated from the faces of the users.

21. The commercial system set forth in claim 20, wherein said appealing power sensor includes an infrared line sensor for measuring the positions and number of the users by detecting infrared rays radiated from the faces of the users.

22. The commercial system set forth in claim 21 wherein said infrared line sensor is provided with a plurality of infrared detecting elements arranged in a matrix form in each of detecting segments corresponding to concentric arc-zonate areas around said automatic vending machine.

23. The commercial system set forth in any of claims 16 to 22, wherein said appealing power sensor operates at intervals of 0.1 to 10 seconds to detect the users therearound at 50 μsec. to 200 μsec.

24. The commercial system set forth in any of claims 15 to 23, wherein the advertisement rate to be charged to a commercial sponsor is determined for each sort of the commercial images and sounds in accordance with the integrated value of at least the releasing time and the appealing power selected from the time of releasing the commercial image with sound from said display unit, the appealing power and the number of users and stored in said memory device of said display unit, while reading out the releasing time and the appealing power from the memory device.

25. The commercial system set forth in any of claims 15 to 23, wherein the advertisement rate to be charged to the commercial sponsor is determined for each sort of the commercial images and sounds in accordance with the integrated value of at least the releasing time and the appealing power selected from the time of releasing the commercial image with sound from said display unit, the appealing power and the number of users and stored in said recording medium of the display unit, while reading out the releasing time and the appealing power from the recording medium.

26. The commercial system set forth in any of claims 15 to 23, wherein the advertisement rate to be charged to the commercial sponsor is determined for each sort of the commercial images and sounds in accordance with the integrated value of at least the releasing time and the appealing power selected from the time of releasing the commercial image with sound from said display unit, the appealing power and the number of users and stored in said recording medium of the display unit, while reading out the releasing time and the appealing power from the recording medium through a wired or wireless line by using a commercial accounting server.

27. The commercial distributing system according to any of claims 11 to 26, wherein the commercial image with sound is continuously released from said display unit in the middle of selling articles by said automatic vending machine at a reduced price or at no charge.

28. The commercial system according to claim 27, wherein a part of advertisement rate collected from the commercial sponsor compensates for the price of the article to be sold by said automatic vending machine at a reduced price or at no charge.

29. The commercial system set forth in any of claims 13 to 26, wherein the appealing power of the commercial image with sound continuously released from said display unit in the middle of selling articles by said automatic vending machine at a reduced price or at no charge is determined at the same level as that in the time of 5 seconds to 30 seconds just after the user has picked out the article from said automatic vending machine when buying.

30. The commercial system set forth in claim 27, 28 or 29, wherein the articles to be sold at a reduced price or at no charge by said automatic vending machine is digital recording media containing at least one of sound and image.

31. The commercial system set forth in any of claims 10 to 30, wherein the sale of articles in said automatic vending machine is allowed by confirming credit worthiness of the user with the use of a personal identification means such as an IC card, personal identification number and credit card, and wherein, when identifying the user using said automatic vending machine, a commercial image with and sound congenial to the user is released from said display unit upon recognizing the personality of the user.

32. The commercial system set forth in any of claims 11 to 31, wherein. when using said automatic vending machine, samples of commercial images by type of commercials are displayed on said display unit, so that the user may select the commercial image of user's own choice from said samples of commercial images by operating a commercial selection means disposed on said automatic vending machine so as to release the selected commercial image for a given length of time.

33. The commercial system set forth in any of claims 11 to 32, wherein said automatic vending machines are categorized to groups according to characteristics peculiar to their installation locations and supplied with commercial images and sounds tailored to the uses' preferences according to the selected groups.

34. The commercial system set forth in any of claims 11 to 33, wherein some of automatic vending machines are selected according to the reservation of a client to supply an commercial image with sound ordered by the client to the selected automatic vending machine and then show the ordered commercial image with sound on said display unit of said selected automatic vending machine.

35. The commercial system set forth in any of claims 11 to 34, wherein one of said commercial providing server and a commercial reception server for inputting the commercial image and sound to said commercial providing server are connected to a system of the registered client through a line network for transmitting data of images and sounds to comply with the client's order for at least one of releasing time and period, estimated cost, service area in addition to the ordered commercial image and sound.

36. The commercial system set forth in any of claims 11 to 35. wherein said commercial supplying source is a cable television provider, satellite broadcasting station, or ground-based broadcasting station.

37. The commercial system set forth in any of claims 11 to 35, wherein said commercial supplying source is one of a public institution including police office, fire station, emergency station, state organization and local governmental units, so as to broadcast a public service announcement with said display unit via the Internet or through the other medium.

38. An appealing power sensor for detecting a commercial effect, comprising an infrared line sensor for measuring the positions and number of the users by detecting infrared rays radiated from the faces of the users, said infrared line sensor including infrared detecting elements arranged in a matrix form in each of detecting segments corresponding to concentric arc-zonate areas disposed around an automatic vending machine.

39. An appealing power sensor set forth in claim 38, wherein said appealing power sensor is operated at intervals of 0.1 to 10 seconds to detect the uses therearound at 50 μsec. to 200 μsec.
